(19) United States
(12) Patent Application Publication
(10) Pub. No.: US 2017/0308733 A1
(43) Pub. Date: Oct. 26, 2017

(54) DISPLAY DEVICE, REMOTE CONTROL DEVICE, DISPLAY SYSTEM AND PROGRAM PUSHING METHOD

(71) Applicant: BOE TECHNOLOGY GROUP CO., LTD., Beijing (CN)

(72) Inventor: JIAN GAO, Beijing (CN)

(73) Assignee: BOE TECHNOLOGY GROUP CO., LTD., Beijing (CN)

(21) Appl. No.: 15/513,336

(22) PCT Filed: Jul. 22, 2016
(86) PCT No.: PCT/CN2016/091035

§ 371 Date: Mar. 22, 2017

(30) Foreign Application Priority Data
Aug. 18, 2015 (CN) 201510509399.0

(51) Int. Cl. G06K 9/00; H04N 21/422

(52) U.S. Cl. CPC G06K 9/00013; H04N 21/422; G06K 9/00067; G06K 9/00087

(57) ABSTRACT

A display device, a remote control device, a display system and a program pushing method are disclosed. The display device includes: a first obtaining module configured to obtain fingerprint feature information of a operation user; a searching module configured to search for a user identity corresponding to the fingerprint feature information obtained by the first obtaining module; a second obtaining module configured to obtain personalized program information according to the user id entity obtained by the searching module.

### TECHNICAL FIELD

Embodiments of the present disclosure relate to a display device, a remote control device, a display system and a program pushing method.

### BACKGROUND

Televisions and other program playing devices have been widely used in people's life. As a common function, the “program collection” function allows a user to store favorite program labels and conveniently open the favorite program labels in a collection menu or startup screen for viewing, which greatly enhances user experience.

However, for the user, an operation process of obtaining personalized program information of collected programs can be very complex. For example, the personalized program information of different members in one family are generally stored together without differentiation, so that when using the “program collection” function, any family member cannot quickly and precisely access collected programs of one's own, and a problem of privacy security of the user is further involved. On the other hand, even if the above problem can be solved to a certain extent by setting a separate account for each user, operations such as registration, first log on, automatic log on, switching log on, and log off and so on can easily bore the user, and the user experience can be affected accordingly.

### SUMMARY

Embodiments of the present disclosure provide a display device, a remote control device, a display system and a program pushing method, which can simplify an operating process for the user to obtain the personalized program information, and can enhance user experience.

For the first aspect, the embodiment of the present disclosure provides a display device, which comprises: a first obtaining module, configured to obtain fingerprint feature information; a searching module, configured to search for a user identity corresponding to the fingerprint feature information; and a second obtaining module, configured to obtain personalized program information according to the user identity.

For example, for the display device provided by the embodiment of the present disclosure, the searching module is configured to search for the user identity corresponding to the fingerprint feature information in a server and/or a local storage.

For example, for the display device provided by the embodiment of the present disclosure, the first obtaining module comprises a receiving unit configured to receive the fingerprint feature information.

For example, for the display device provided by the embodiment of the present disclosure, the first obtaining module comprises: a fingerprint detection unit disposed in at least one button region, configured to generate a fingerprint detection signal when being touched and send the fingerprint detection signal; and a processing unit, configured to receive and process the fingerprint detection signal from the fingerprint detection unit, so as to obtain the fingerprint feature information.

For example, for the display device provided by the embodiment of the present disclosure, further comprises: a storage module, configured to upload the fingerprint feature information in the case that the searching module cannot find a user identity corresponding to the fingerprint feature information, so as to establish a corresponding user identity.

For example, for the display device provided by the embodiment of the present disclosure, further comprises a pushing module configured to push a corresponding program according to the personalized program information.

For the second aspect, the embodiment of the present disclosure further provides a remote control device, which comprises: a fingerprint detection module disposed in at least one button region, and configured to generate a fingerprint detection signal when being touched and send the fingerprint detection signal; a processing module, configured to receive and process the fingerprint detection signal from the fingerprint detection module, so as to obtain fingerprint detection information; and a sending module, configured to send the fingerprint feature information obtained by the processing module to a display device.

For example, for the remote control device provided by the embodiment of the present disclosure, the at least one button region comprises any one or more of following regions: a switch On/Off button region, a volume up button region, a volume down button region, a channel switch button region, a confirmation button region, a cancel button region and a return button region.

For the third aspect, the embodiment of the present disclosure further provides a display system, which comprises: the display device according to any one of the first aspect, and the remote control device according to any one of the second aspect.

For the fourth aspect, the embodiment of the present disclosure further provides a remote control device, which comprises: a fingerprint detection module disposed in at least one button region, and configured to generate a fingerprint detection signal when being touched and send the fingerprint detection signal; a processing module, configured to receive and process the fingerprint detection signal from the fingerprint detection module, so as to obtain fingerprint feature information; a searching module, configured to search for a user identity corresponding to the fingerprint feature information obtained by the processing module; and a sending module, configured to send the user identity searched by the searching module.

For example, for the remote control device provided by the embodiment of the present disclosure, the searching module is configured to search for the user identity corresponding to the fingerprint feature information obtained by the processing module in a server and/or a local storage.

For example, for the remote control device provided by the embodiment of the present disclosure, which further comprises: a storage module, configured to upload the fingerprint feature information in the case that the searching module cannot find a user identity corresponding to the fingerprint feature information, so as to establish a corresponding user identity.

For example, for the remote control device provided by the embodiment of the present disclosure, the at least one button region comprises any one or more of following regions: a switch On/Off button region, a volume up button region, a volume down button region, a channel switch button region, a confirmation button region, a cancel button region and a return button region.

For the fifth aspect, the embodiment of the present disclosure further provides a display device, which comprises: a receiving module, configured to receive a user identity from a remote control device; and a second obtaining module, configured to obtain personalized program information according to the user identity received by the receiving module.

For example, for the display device provided by the embodiment of the present disclosure, which further comprises: a pushing module, configured to push a corresponding program according to the personalized program information.

For the sixth aspect, the embodiment of the present disclosure further provides a display system, which comprises: the display device according to any one of the fourth aspect, and the remote control device according to any one of the fifth aspect.

For the seventh aspect, the embodiment of the present disclosure further provides a program pushing method, which comprises: obtaining fingerprint feature information; searching for a user identity corresponding to the fingerprint feature information; and obtaining personalized program information according to the user identity.

For example, for the program pushing method provided by the embodiment of the present disclosure, further comprises: pushing a corresponding program according to the personalized program information.

For example, for the program pushing method provided by the embodiment of the present disclosure, the obtaining the fingerprint feature information comprises: receiving the fingerprint feature information.

For example, for the program pushing method provided by the embodiment of the present disclosure, the obtaining the fingerprint feature information comprises: generating a fingerprint detection signal; and processing the fingerprint detection signal to obtain the fingerprint feature information.

For example, for the program pushing method provided by the embodiment of the present disclosure, further comprises: uploading the fingerprint feature information in the case that the user identity is not found, so as to establish a corresponding user identity.

The embodiments of the present disclosure associate the fingerprint feature information of the user with the personalized program information, and can automatically finish processes of identity authentication of the user and obtaining of the personalized program information under a condition that the user barely senses, and the operating process for the user to obtain the personalized program information is greatly simplified.

The embodiments of the present disclosure can realize sharing of the same type of devices, that is, a same user can conveniently obtain the personalized program information of one's own from different devices; and in addition, as a security authentication method, fingerprint recognition can ensure privacy security of the user while using the devices.

### BRIEF DESCRIPTION OF THE DRAWINGS

In order to clearly explain technical solutions of present disclosure or prior art, drawings used in description of the embodiments or the prior art will be briefly described. It is obvious that the described drawings below are only related to some embodiments of the disclosure, and those ordinary skilled in the art can obtain other drawings according to these drawings without any inventive work.

FIG. 1 is a structural block diagram of a display device in one embodiment of the present disclosure;

FIG. 2 is a structural schematic diagram of a first obtaining module in one embodiment of the present disclosure;

FIG. 3 is a structural block diagram of a remote control device in one embodiment of the present disclosure;

FIG. 4 is a structural block diagram of a display system in one embodiment of the present disclosure;

FIG. 5 is a flow chart of turning on a television in one embodiment of the present disclosure;

FIG. 6 is a structural schematic diagram of a remote control device in another embodiment of the present disclosure;

FIG. 7 is a structural block diagram of a display device in another embodiment of the present disclosure;

FIG. 8 is a structural block diagram of a display system in another embodiment of the present disclosure;

FIG. 9 is a schematic block diagram of a display device in the embodiment of the present disclosure;

FIG. 10 is a schematic block diagram of a remote control device in the embodiment of the present disclosure; and

FIG. 11 is a flow chart of a program pushing method in one embodiment of the present disclosure.

### DETAILED DESCRIPTION

In order to make objects, technical details and advantages of the embodiments of the disclosure apparent, the technical solutions of embodiments of the present disclosure will be described in a clearly and fully understandable way in connection with the drawings. It is obvious that the described embodiments are just a part but not all of the embodiments of the disclosure. Based on the described embodiments herein, those skilled in the art can obtain other embodiment(s), without any inventive work, which should be within the scope of the disclosure.

For example, FIG. 1 is a structural block diagram of a display device 10 in one embodiment of the present disclosure. Referring to FIG. 1, the display device 10 comprises a first obtaining module 11, configured to obtain fingerprint feature information of an operation user; a searching module 12, configured to search for a user identity corresponding to the fingerprint feature information obtained by the above first obtaining module 11 in a server and/or a local storage; and a second obtaining module 13, configured to obtain personalized program information of the user according to the user identity obtained by the above searching module 12.

For example, in order to obtain the fingerprint feature information of the operation user, the first obtaining module 11 can include a fingerprint recognition unit disposed in and/or around a user operating region (for example a key region, a button region, a touch region, etc.). The fingerprint recognition unit can be realized based on an existing optical-type fingerprint recognition technology, a capacitive-type fingerprint recognition technology, an ultrasonic-type fingerprint recognition technology or a radiofrequency-type fingerprint recognition technology, and the fingerprint recognition unit, for example, includes a surface electrode being in contact with fingers, a silicon chip or a silicon chip array, a backlight source or an ultrasonic generator, etc., and can further include a calculating unit for extracting the fingerprint feature information, and those skilled in the art can set the fingerprint recognition unit with reference to the prior art, which is not limited in the present disclosure.

For example, after the fingerprint feature information of the operation user is obtained, the searching module 12 can access a corresponding server by wired network or wireless network connection and can search for the user identity corresponding to the fingerprint feature information in the server; the concrete searching process can include confirmation of an identifier of the display device, screening of a target user identity, matching between the fingerprint feature information and the user identity, and the like. After the user identity is obtained, the second obtaining module 13 can be connected to the server through a wired network or a wireless network so as to obtain the personalized program information corresponding to the user identity. Of course, in the case that a fingerprint information database and a personalized program information database are both stored in the server, functions of the searching module 12 and the second obtaining module 13 can be realized in a same access of the display device to the server, which is not limited in the present disclosure.

For example, the display device 10 can include a local storage for storing the fingerprint feature information, user identity and personalized program information, such that a process that the searching module 12 searches for the user identity and a process that the second obtaining module 13 obtains the personalized program information can be both performed in the local storage. When the network connection of the display device 10 is usable, the fingerprint feature information, user identity and personalized program information in the local storage and the server can be mutually synchronized; while, for example, in the case that the display device does not include the network connection function, the obtaining of the personalized program information can also be realized based on the local storage only.

For example, the display device in the present embodiment can be any product or part having a display function, such as a display panel, an electronic paper, a mobile phone, a tablet computer, a television, a laptop, a digital photo frame and a navigator, etc. It is appreciated that the display device, for example, has a program playing function. For example, the display device in the embodiment of the present disclosure is a television, which can automatically finish processes of fingerprint recognition, identity authentication, obtaining of the personalized program information, etc., during user's key operation, and can improve a viewing experience of the user.

For example, the embodiment of the present disclosure associates the fingerprint feature information of the user with the personalized program information of the user, and can automatically finish processes of identity authentication of the user and obtaining of the personalized program information under the condition that the user barely senses, and an operating process for the user to obtain the personalized program information is greatly simplified. Besides, the embodiment of the present disclosure can realize sharing of the same type of devices, that is, the same user can conveniently obtain the personalized program information of one's own on different devices (for example, different devices at different locations); and in addition, as a security authentication method, the fingerprint recognition can ensure the privacy security of the user while using the devices.

For example, in the process that a certain user uses the television at home, the television can upload the fingerprint feature information and the personalized program information of the user to the server correspondingly. Therefore, when the user uses another television (for example, a same type of television) at another location, the television will collect the fingerprint feature information of the user automatically according to the above flow and obtain the personalized program information of the user from the server and provide a personalized service for the user. It is appreciated that for example, under a scenario that the television stores the fingerprint feature information and the personalized program information only in the local storage, the user can store the above information through a portable storage and obtain the personalized service by installing the portable storage before using another television of the same type. Besides, it can be seen that the fingerprint feature information in the above process serves as a secret key of the user, and can ensure the privacy security of the user during the usage of the televisions.

For example, after the personalized program information is obtained, the display device can push programs accordingly. For example, as illustrated in FIG. 1, the display device 10 can further comprise a pushing module 15, which is configured for pushing a corresponding program (for example, a program with longest viewing time of the user, a program manually collected by the user, a program that the user finally views during usage of the last time, etc.) to the user according to the personalized program information obtained by the second obtaining module 13. Therefore, the display device can push user's favorite programs to the user while the user performs conventional operations, which is favorable for improving user experience.

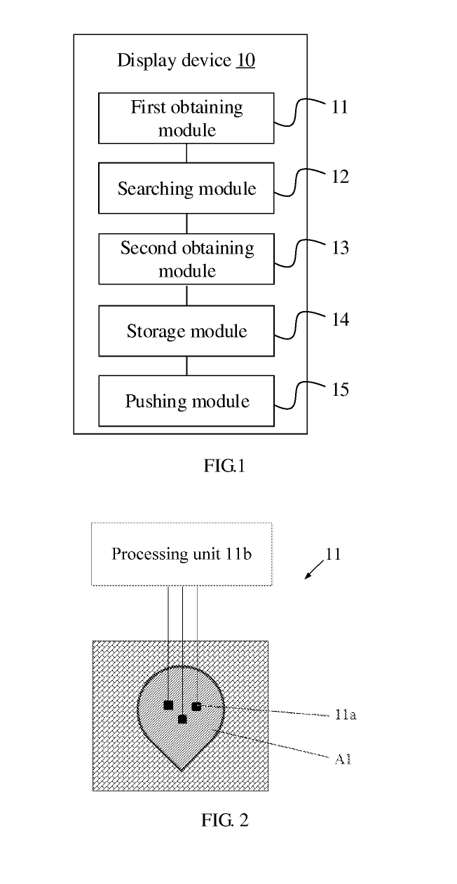

For example, as a specific example of the first obtaining module 11, FIG. 2 is a structural schematic diagram of the first obtaining module in one embodiment of the present disclosure. Referring to FIG. 2, the above first obtaining module 11 can specifically include the following structures: a fingerprint detection unit 11a, which is disposed in at least one button region, for generating a fingerprint detection signal when a touch action being sensed; a processing unit 11b, for receiving and processing the fingerprint detection signal from the above fingerprint detection unit 11a, so as to obtain the above fingerprint feature information.

For example, the at least one button region can include a switch On/Off button region, a volume up button region, a volume down button region, a channel switch button region, a confirmation button region, a cancel button region or a return button region. For example, FIG. 2 takes the switch On/Off button region A1 as an example for illustrating a disposing manner of the above fingerprint detection unit 11a. The fingerprint detection unit 11a disposed in the switch On/Off button region A1 can generate the fingerprint detection signal containing the user fingerprint information when sensing a touch action based on any fingerprint recognition technology; while the processing unit 11b can be connected to the fingerprint detection unit 11a to receive the fingerprint detection signal, and realize extraction of the fingerprint feature information based on a corresponding fingerprint recognition technology. For example, the switch On/Off button region A1 is a region which must be touched when the user uses the display device; and therefore, by using the above structure, the fingerprint recognition, identity authentication and extraction of the personalized program information can be automatically performed after the user turns the display device on, such that a corresponding personalized service can be provided for the user and user experience can be enhanced.

For example, as an example of an establishing method of the user identity, as illustrated in FIG. 1, the display device 10 further includes a storage module 14. The storage module 14 is configured for uploading the fingerprint feature information obtained by the first obtaining module 11 to the above server and/or storing the fingerprint feature information to the local storage in the case that the user identity is not found by the searching module, so as to establish a corresponding user identity. For example, when a certain user uses the display device for the first time, the security setting of the display device can be set to allow an unfamiliar user to use. After the user turns the display device on, the first obtaining module 11 has obtained the fingerprint feature information of the user, such that the storage module can store the fingerprint feature information and establish the corresponding user identity. While used by the user, the display device can generate personalized program information according an access record of the user, and can push a corresponding program by the pushing module when the user turns the display device on next time.

For example, as another specific example of the first obtaining module 11, the above obtaining module 11 can specifically include a receiving unit not illustrated in the drawing. The receiving unit is configured for receiving the fingerprint feature information from a remote control device; the fingerprint feature information is obtained through processing of a fingerprint detection signal by the remote control device; the fingerprint detection signal is generated when the remote control device senses a touch action in at least one button region.

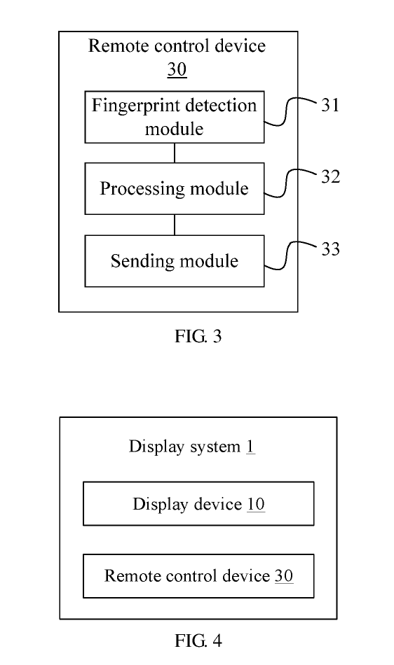

For example, FIG. 3 is a structural block diagram of a remote control device 30 in one embodiment of the present disclosure. Referring to FIG. 3, the remote control device 30 includes: a fingerprint detection module 31, which is disposed in at least one button region, for generating a fingerprint detection signal when a touch action is sensed; a processing module 32, for receiving and processing the fingerprint detection signal from the above fingerprint detection module 31, so as to obtain a fingerprint feature information; and a sending module 33, for sending the fingerprint feature information obtained by the processing module 32 to the display device, so as to allow the display device to search for a user identity corresponding to the fingerprint feature information in a server and/or a local storage, and obtain a personalized program information corresponding to the user identity after successful searching of the user identity.

For example, based on the above structure, the remote control device can collect the fingerprint feature information of the user when the user touches the above at least one button region and can send the fingerprint feature information to the first obtaining module 11 of the above display device, so as to realize that the display device obtains the fingerprint feature information of an operation user. For example, the remote control device 30 can be matched with the display device 10 for use. Therefore, one embodiment of the present disclosure provides a display system 1, and as illustrated in FIG. 4, the display system 1 comprises any remote control device 30 described above and any display device 10 described above. For example, in the case that the above display device 10 is a television, the remote control device 30 can be a remote controller of the television.

It is noted that when multiple users operate the remote control device and the display device successively, a user authentication identity can be that of the last operated user, thus ensuring that the determined personalized program information corresponds to the current operation user. In addition, in view of different security settings, the remote control device can further include an alarm module, which sends a message to the display device in the case that change of the operation user is detected, to allow the display device to hide or cancel user information of other users, so as to ensure privacy security of the user. Of course, the alarm module can be disposed in any display device described above.

In the remote control device, the at least one button region can include any one or more of: a switch On/Off button region, a volume up button region, a volume down button region, a channel switch button region, a confirmation button region, a cancel button region or a return button region. On this basis, the remote control device can collect the fingerprint feature information of the user while the user operating the common button regions, so as to realize real time authentication of the user identity.

For example, the remote control device provided by the embodiment of the present disclosure can perform collection and sending of the fingerprint feature information, such that when the user uses the remote control device to operate the display device (for example, uses the remote control device to turn on the display device, or uses the remote control device to switch a program or adjust a volume), the display device can automatically obtain the personalized program information, which is favorable to further enhance the user experience.

For example, the first obtaining module in the display device provided by the embodiment of the present disclosure includes a fingerprint detection unit; meanwhile, the remote control device provided by the embodiment of the present disclosure includes a fingerprint detection module; in this way, when the user operates the display device or the remote control device, the fingerprint detection signal will be obtained by the display device or the remote control device, and the user experience is enhanced.

For example, as a more specific example, FIG. 5 is an exemplary flow chart of turning on a television in one embodiment of the present disclosure. Referring to FIG. 5, when the user touches the switch On/Off button region, the fingerprint detection unit in such region can generate a fingerprint detection signal, and the processing unit can perform analysis, extraction and correction of the fingerprint feature information after the television is turned on. Next, the searching module 12 can compare the obtained fingerprint feature information with the fingerprint feature information stored in a local storage or a cloud server, and determines whether a user identity matches with an authenticated user or not. After the determination of the user identity being matched with the authenticated user, the second obtaining module 13 can obtain corresponding personalized program information to allow the pushing module to push a channel with the user's favorite program to the user under an authenticated user mode. When the identity information is not matched with any one of the authenticated users, the storage module can store the fingerprint feature information to the local storage or the cloud server to establish a corresponding user identity in a fingerprint information base and the television enters a common user mode, and the pushing module can push random television channels.

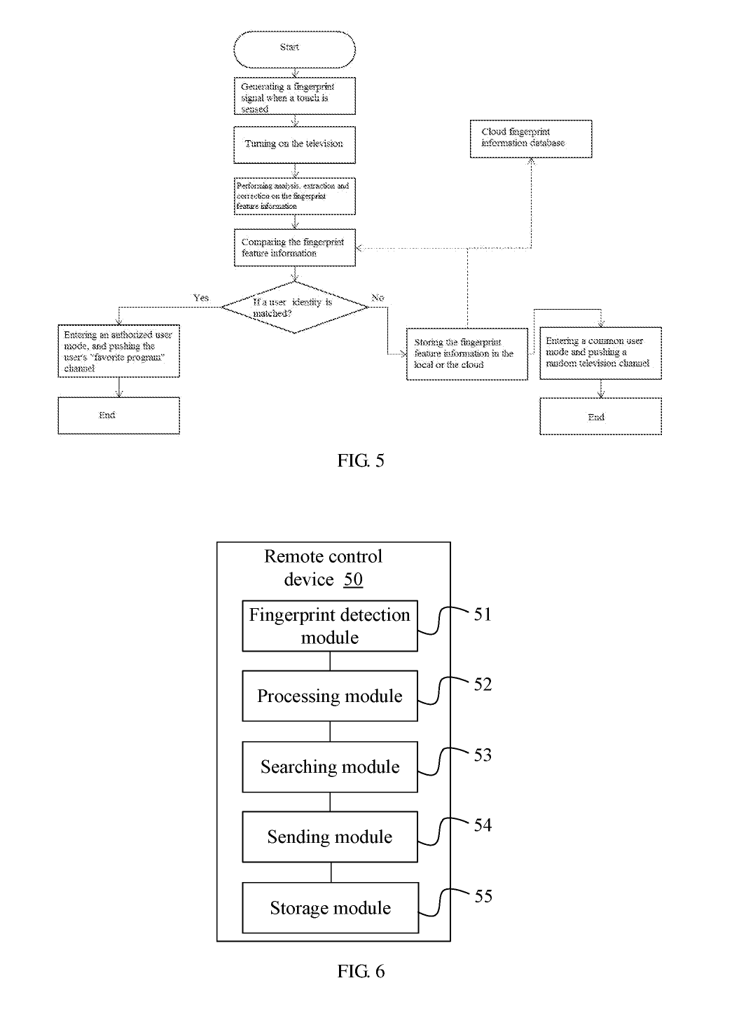

For example, FIG. 6 is a structural schematic diagram of a remote control device 50 in another embodiment of the present disclosure. Referring to FIG. 6, the remote control device 50 includes: a fingerprint detection module 51, which is disposed in at least one button region, configured for generating a fingerprint detection signal when a touch action is sensed; a processing module 52 configured for receiving and processing the fingerprint detection signal from the fingerprint detection module 51, so as to obtain fingerprint feature information; a searching module 53 configured for searching for a user identity corresponding to the fingerprint feature information obtained by the above processing module 52 in a server and/or a local storage; a sending module 54 configured for sending the user identity obtained by the searching module 53 to the display device, so as to allow the display device to obtain personalized program information of the user according to the user identity.

For example, the fingerprint detection module 51 and the processing module 52 can have structures the same as or similar to those of the fingerprint detection module 31 and the processing module 32, while the searching module 53 can have a structure the same as or similar to that of the searching module 12 in FIG. 1, which are not repeated herein. It can be seen that the remote control device in the embodiment of the present disclosure can realize functions of fingerprint recognition and user identity authentication in the display device, and therefore has corresponding structures and functions, which are not repeated herein.

For example, the at least one button region includes any one or more of the following: a switch On/Off button region, a volume up button region, a volume down button region, a channel switch button region, a confirmation button region, a cancel button region or a return button region. On this basis, the remote control device can collect the fingerprint feature information of the user while the user operating the common button regions, so as to realize real-time authentication of the user identity.

For example, as illustrated in FIG. 6, the remote control device 50 can further include a storage module 55; the storage module 55 is configured for uploading the fingerprint feature information obtained by the above processing module 52 to the above server and/or storing the fingerprint feature information to the local storage in the case that the searching module 53 cannot find the user identity corresponding to the fingerprint feature information obtained by the first obtaining module in the server and/or the local storage, so as to establish a corresponding user identity.

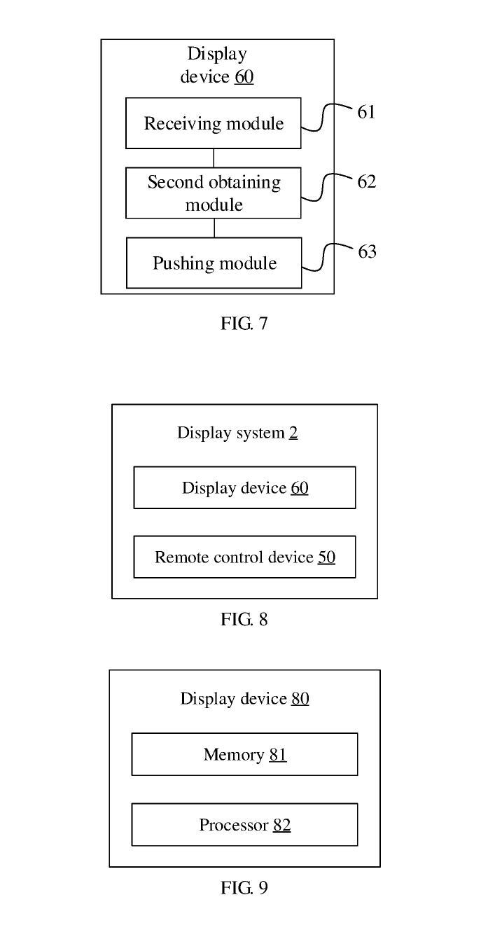

Corresponding to the remote control device as illustrated in FIG. 6, FIG. 7 is a structural block diagram of a display device 60 in another embodiment of the present disclosure. Referring to FIG. 7, the display device 60 comprises:

a receiving module 61 configured for receiving a user identity from the remote control device, the above user identity corresponds to the fingerprint feature information, and is obtained by searching in the server and/or the local storage according to the above fingerprint feature information through the remote control device; the above fingerprint feature information is obtained through processing of a fingerprint detection signal by the remote control device; and the fingerprint detection signal is generated when the remote control device senses a touch action in at least one button region;

a second obtaining module 62 configured for obtaining personalized program information of the user according to the user identity obtained by the above receiving module.

For example, the second obtaining module 62 can have a structure the same as or similar to that of the second obtaining module 13 illustrated in FIG. 1, which is not repeated herein. It can be seen that compared with the display device illustrated in FIG. 1, the display device provided by the embodiment of the present disclosure can obtain a user identity through the remote control device, and a subsequent process can be consistent with the display device illustrated in FIG. 1. For example, the display device 60 can further include a pushing module 63, which is configured for pushing a corresponding program (for example, a program with longest viewing time of the user, a program manually collected by the user, a program that the user finally views during usage of the last time, etc.) to the user according to the personalized program information obtained by the second obtaining module 62. Therefore, the display device can push user's favorite programs to an operation user while the user performs conventional operations (for example, turning on the display device, channel switching, volume adjusting, etc.), which is favorable for enhancing the user experience.

It is noted that the display device in the present embodiment can be any product or part having a display function such as a display panel, an electronic paper, a mobile phone, a tablet computer, a television, a laptop, a digital photo frame and a navigator, etc. It is appreciated that the display device has a program playing function. Therefore, one embodiment of the present disclosure provides a display system 2, and as illustrated in FIG. 8, the display system 2 comprises any remote control device 50 illustrated in FIG. 6 and any display device 60 illustrated in FIG. 7. For example, the display device in the embodiment of the present disclosure is a television, the remote control device is a remote controller of the television, the processes such as fingerprint recognition, identity authentication, obtaining of personalized program information and the like can be automatically finished when the user presses a key to operate the remote control, and a program viewing experience of the user can be enhanced.

For example, the display device and/or remote control device provided by the embodiment of the present disclosure includes a processor and a memory.

For example, as illustrated in FIG. 9, the display device 80 comprises a memory 81 and a processor 82.

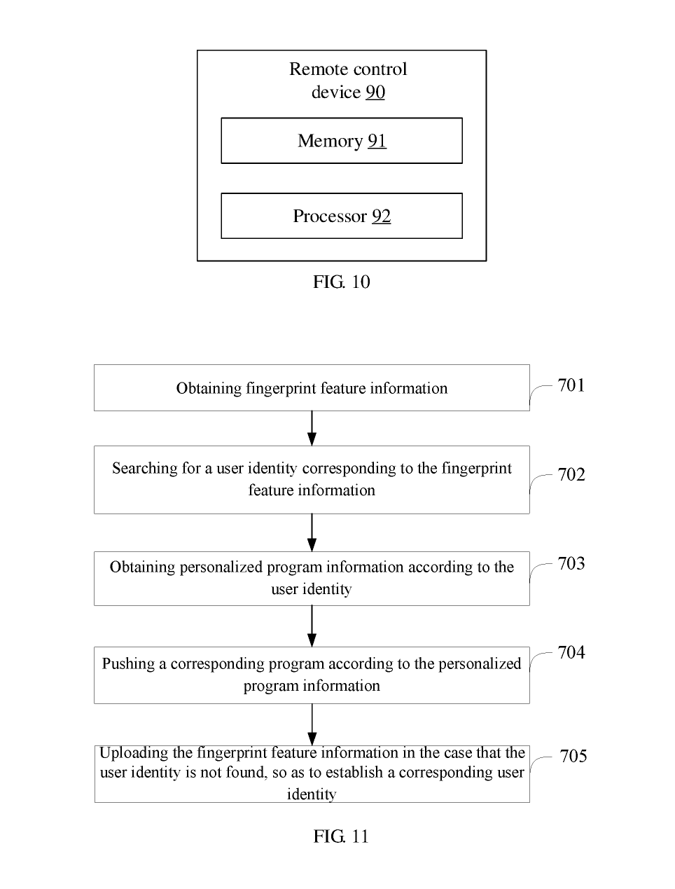

For example, as illustrated in FIG. 10, the remote control device 90 comprises a memory 91 and a processor 92.

In the embodiment of the present disclosure, the processor can process a digital signal, and can include various computing structures, for example, a Complex Instruction Set Computer (CISC) structure, a Reduced Instruction Set Computer (RISC) structure, or a structure implementing combinations of multiple instruction sets. In some embodiments, the processor can be a microprocessor, for example, an X86 processor or an ARM processor, or a Digital Signal Processor (DSP), etc.

In the embodiment of the present disclosure, the memory can store an instruction and/or data executed by a processor. For example, the memory can include one or more computer program products, and the computer program product can include computer readable storage mediums of various forms, for example, a volatile memory and/or a nonvolatile memory. The volatile memory for example can include a Random Access Memory (RAM) and/or a cache, etc. The nonvolatile memory, for example, can comprise a Read-Only Memory (ROM), a hard disk, a flash memory and the like. The computer readable storage mediums can store one or more computer program instructions, the processor can execute the program instructions to realize (realized by the processor) functions expected in the embodiments of the present disclosure mentioned above. The computer readable storage mediums can further store various application programs and various data, for example, the various data used and/or generated by the application programs, etc.

For example, an embodiment of the present disclosure provides a display device, which comprises a display panel, a memory, one or more processors and one or more modules, the one or more modules are stored in the memory and configured to be executed by the one or more processors, the one or more modules include instructions of: obtaining a fingerprint feature information; searching for a user identity corresponding to the fingerprint feature information; and obtaining a personalized program information according to the user identity.

For example, FIG. 11 is a flow chart of a program pushing method in one embodiment of the present disclosure. Referring to FIG. 11, the method comprises:

Step 701: obtaining fingerprint feature information of an operation user;

Step 702: searching for a user identity (for example, searching for the user identity corresponding to the above fingerprint feature information in a server and/or a local storage) corresponding to the above fingerprint feature information;

Step 703: obtaining personalized program information of a user according to the above user identity;

Step 704: pushing a corresponding program to the user according to the above personalized program information.

For example, the method can be realized by a display device provided by the embodiments of the present disclosure, a remote control device provided by the embodiments of the present disclosure, or a combination thereof, and thus can comprise a corresponding concrete processes, which are not repeated herein.

For example, the embodiments of the present disclosure associate the fingerprint feature information of the user with the personalized program information of the user, such that the identity authentication of the user and obtaining of the personalized program information can be automatically finished under a condition the user barely senses, and an operating process for the user to obtain the personalized program information is greatly simplified. Besides, the embodiments of the present disclosure can realize the sharing of the same type of devices, that is, the same user can conveniently obtain personalized program information of one's own on different devices; and in addition, as a security authentication method, fingerprint recognition can ensure privacy security of the user while using the devices.

As an example, the above step 701 (that is, obtaining the fingerprint feature information of an operation user) can include the following steps not illustrated in the drawing:

Step 701a: receiving the fingerprint feature information from a remote control device.

For example, the fingerprint feature information is obtained through processing of the fingerprint detection signal by the remote control device; and the fingerprint detection signal is generated by the remote control device in the case that a touch action in at least one button region is sensed.

For example, the fingerprint feature information can originate from the remote control device operated by the user, such that the method can realize obtaining of the fingerprint feature information while the user performs conventional operations (for example, turning on the display device, channel switching, volume adjusting, etc.).

As another example, the step 701 (that is, obtaining the fingerprint feature information of an operation user) can include the following steps not illustrated in the drawing:

Step 701b: generating a fingerprint detection signal when any button in at least one button region is touched;

Step 701c: processing the fingerprint detection signal to obtain fingerprint feature information.

For example, the fingerprint feature information can originate from an operation of the user in the button region, and on this basis, the fingerprint feature information of the user can be obtained based on a fingerprint recognition technology by operation of the user.

For example, as illustrated in FIG. 11, the method can further include the following steps:

Step 705: uploading the fingerprint feature information to the server and/or storing the fingerprint feature information to the local storage in the case that the user identity is not found in the server and/or the local storage, so as to establish a corresponding user identity.

For example, when a certain user uses the display device for the first time, the security setting of the display device can be set to allow an unfamiliar user to use. After the user turns the display device on, the fingerprint feature information of the user has been obtained during the above step 701, such that the fingerprint feature information can be stored and the corresponding user identity can be established in the above step 705. While used by the user, the display device can generate personalized program information according an access record of the user, and can push a corresponding program by the pushing module when the user turns the display device on next time.

For the description of the present disclosure, it should be understood that, the directional or positional relationships indicated by the terms such as “upper”, “lower” are based on the directional or positional relationships illustrated in the drawings, the terms are used to facilitate the description of the disclosure and simplify the description, and are not indicate or imply that the devices or components must have specific directions, or be constructed or operated in the specific directions, and are not limitative to the disclosure. Unless expressly stipulated or defined, terms such as “mounted”, “connected” and “linked” should be broadly understood, for example, “connected” can be fixedly connected, detachably connected, or integrally connected; “connected” can also be mechanically connected or electrically connected; “connected” can be directly connected, indirectly connected by a medium, or internally connected between two components. Those ordinary skilled in the art can understand specific meaning of the above terms in the present disclosure according to specific conditions.

Massive of specific details are described in the specification of the present disclosure. However, it is appreciated that the embodiments of the present disclosure can be implemented without these specific details. In some embodiments, well known methods, structures and technologies are not illustrated in detail to clarify understandings of the present specification.

Similarly, it should be understood that in order to simplify the present disclosure and help to understand one or more of respective aspects, in the above description of the exemplary embodiments of the present disclosure, respective characteristics of the present disclosure are sometimes grouped into single embodiment, drawing or description thereof. However, the disclosed method of the present disclosure shouldn't be explained to indicate the following intention: that is, the present disclosure claimed to be protected requires more features than those clearly recorded in each claim. To be more specific, as indicated by the claims, the inventive aspects have less features than all of those in a single embodiment disclosed above. Therefore, the claims complying with specific embodiments are clearly merged into the specific embodiments, and each claim per se serves as a single embodiment of the present disclosure.

It should be understood that the above embodiments are intended for explaining rather than limiting the present disclosure, and those skilled in the art can design alternate embodiments without departing the scope of the accompanying claims. In the claims, any reference sign in brackets shouldn't limit the claims in any form. The word “containing” does not exclude the existence of elements or steps not in the claims. The word “a” or “an” in front of an element does not exclude the existence of multiple of such element. The present disclosure can be implemented by means of hardware including a plurality of different elements and a properly programmed computer. In the unit claims with a plurality of devices listed, a plurality of these devices can be specifically embodied by a same hardware item. Use of the words “first, second, third and the like” does not represent any sequence. These words can be interpreted as names.

Finally, it is noted that the above respective embodiments are merely intended for explaining rather than limiting the technical solutions of the present disclosure; although the present disclosure is explained in detail with reference to respective embodiments, those ordinary skilled in the art should understand that they can still modify the technical solutions recorded in respective embodiments, or equivalently substitute part or all of the technical features therein; and these modifications or substitutions do not cause the corresponding technical solutions to fall out of the scope of the technical solutions of respective embodiments of the present disclosure and should be within the scope of the claims and specification of the present disclosure.

The application claims priority of Chinese Patent Application No. 201510509399.0 filed on Aug. 18, 2015, the disclosure of which is incorporated herein by reference in its entirety as part of the present application.

1. A display device, comprising:
a first obtaining module, configured to obtain fingerprint feature information;
a searching module, configured to search for a user identity corresponding to the fingerprint feature information; and
a second obtaining module, configured to obtain personalized program information according to the user identity.

2. The display device according to claim 1, wherein the searching module is configured to search for the user identity corresponding to the fingerprint feature information in a server and/or a local storage.

3. The display device according to claim 1, wherein the first obtaining module comprises:
a receiving unit, configured to receive the fingerprint feature information.

4. The display device according to claim 1, wherein the first obtaining module comprises:
a fingerprint detection unit disposed in at least one button region, configured to generate a fingerprint detection signal upon being touched and send the fingerprint detection signal; and
a processing unit, configured to receive and process the fingerprint detection signal from the fingerprint detection unit, so as to obtain the fingerprint feature information.

5. The display device according to claim 1, further comprising:
a storage module, configured to upload the fingerprint feature information in a case that the searching module cannot find a user identity corresponding to the fingerprint feature information, so as to establish a corresponding user identity.

6. The display device according to claim 1, further comprising:
a pushing module, configured to push a corresponding program according to the personalized program information.

7. (canceled)

8. (canceled)

9. A display system, comprising the display device according to claim 1 and a remote control device, wherein the remote control device comprises:
a fingerprint detection module disposed in at least one button region, and configured to generate a fingerprint detection signal upon being touched and send the fingerprint detection signal;
a processing module, configured to receive and process the fingerprint detection signal from the fingerprint detection module, so as to obtain fingerprint detection information; and
a sending module, configured to send the fingerprint feature information obtained by the processing module to a display device.

10. A remote control device, comprising:
a fingerprint detection module disposed in at least one button region, and configured to generate a fingerprint detection signal upon being touched and send the fingerprint detection signal;
a processing module, configured to receive and process the fingerprint detection signal from the fingerprint detection module, so as to obtain fingerprint feature information;
a searching module, configured to search for a user identity corresponding to the fingerprint feature information obtained by the processing module; and
a sending module, configured to send the user identity searched by the searching module.

11. The remote control device according to claim 10, wherein the searching module is configured to search for the user identity corresponding to the fingerprint feature information obtained by the processing module in a server and/or a local storage.

12. The remote control device according to claim 10, further comprising:
a storage module, configured to upload the fingerprint feature information in a case that the searching module cannot find a user identity corresponding to the fingerprint feature information, so as to establish a corresponding user identity.

13. The remote control device according to claim 10, wherein the at least one button region comprises any one or more of following regions: a switch On/Off button region, a volume up button region, a volume down button region, a channel switch button region, a confirmation button region, a cancel button region and a return button region.

14. (canceled)

15. (canceled)

16. A display system, comprising the remote control device according to claim 10, and a display device, wherein the display device comprises:
a receiving module, configured to receive a user identity from a remote control device; and
a second obtaining module, configured to obtain personalized program information according to the user identity received by the receiving module.

17. (canceled)

18. (canceled)

19. (canceled)

20. (canceled)

21. (canceled)

22. A display device, comprising:
a display panel;
a memory;
one or more processors; and
one or more modules, stored in the memory and configured to be executed by the one or more processors, the one of more modules including instructions of:
obtaining fingerprint feature information;
searching for a user identity corresponding to the fingerprint feature information; and
obtaining personalized program information according to the user identity.

23. The display system according to claim 9, wherein the at least one button region comprises any one or more of following regions: a switch On/Off button region, a volume up button region, a volume down button region, a channel switch button region, a confirmation button region, a cancel button region and a return button region.

24. The display system according to claim 16, wherein the display device further comprises:
a pushing module, configured to push a corresponding program according to the personalized program information.

25. The display device according to claim 22, wherein the one of more modules further includes an instruction of pushing a corresponding program according to the personalized program information.

26. The display device according to claim 22, wherein the obtaining the fingerprint feature information comprises:
receiving the fingerprint feature information.

27. The display device according to claim 22, wherein the obtaining the fingerprint feature information comprises:
generating a fingerprint detection signal; and
processing the fingerprint detection signal to obtain the fingerprint feature information.

28. The display device according to claim 22, wherein the one of more modules further includes an instruction of uploading the fingerprint feature information in a case that the user identity is not found, so as to establish a corresponding user identity.
